(19) United States
(12) Patent Application Publication
(10) Pub. No.: US 2013/0111460 A1
(43) Pub. Date: May 2, 2013

(54) METHOD AND SYSTEM FOR LOCALIZING AN APPLICATION ON A COMPUTING DEVICE

(71) Applicant: CIT GLOBAL MOBILE DIVISION, Cairo (EG)

(72) Inventors: Mohamed Ramadan Mohamed Selim MOHAMED, Cairo (EG); Haitham Farouk Mohammed FAHEM, Cairo (EG)

(73) Assignee: CIT GLOBAL MOBILE DIVISION, Cairo (EG)

(21) Appl. No.: 13/665,860

(22) Filed: Oct. 31, 2012

(30) Foreign Application Priority Data
Nov. 1, 2011 (CA) 2756102

(51) Int. Cl. G06F 9/44; G06F 9/445

(52) U.S. Cl. 717/172; 717/176

(57) ABSTRACT

A method and system for localizing an application on a computing device is provided. A software agent executing on a computing device determines if a localization is available on a server computer for an application installed on the computing device. The localization is received and installed on the computing device.

### CROSS-REFERENCE TO RELATED APPLICATIONS

This application claims priority to, and claims the benefit of, Canadian Patent Application No. 2,756,102 filed Nov. 1, 2011, which is incorporated herein by reference in its entirety for all purposes.

### STATEMENT REGARDING FEDERALLY SPONSORED RESEARCH OR DEVELOPMENT

Not Applicable.

### FIELD OF THE INVENTION

The present invention relates generally to software applications. More particularly, the present invention relates to a method and system for localizing an application on a computing device.

### BACKGROUND OF THE INVENTION

The installation of applications on computing devices is known. Computing devices include personal desktop computers, notebook computers, control panels, mobile devices, such as smartphones, tablets, music player devices, GPS navigators, etc. In the case of smartphones, such as Apple iPhones, Windows Mobile devices, RIM Blackberry devices, and Google Android devices, a user interacts with an application store to browse applications and select one or more of the applications for installation on the mobile device. Such application stores are typically accessed through a website or an application on a personal computer or mobile device. The user can have an account with the application store and purchase applications for use on the mobile device. In some cases, the user may be asked for credentials for an account that may be charged for the downloading of the application. The user may also be asked to confirm that one or more conditions are met (such as age, location, or acceptance of an agreement) before download of the application is permitted. Upon providing the credentials and confirmation(s), if any, a downloader agent on the mobile device authenticates with the application store and downloads an application package for the application. Upon downloading the application package from the application store, an installation agent typically copies the application package, which includes one or more executables and configuration files, to a location in storage of the mobile device and may create a shortcut on a menu to install the application.

In few cases, applications available through an application store are pre-configured to present user interface (“UI”) text elements, such as menus, etc., in a number of languages. This is generally achieved by separating text displayed by an application in generating messages, menus, etc. from the executable functionality itself. The text that populates a particular text element of the user interface is referred to as a text string. The text strings are then stored in a separate resource file. By providing a resource file for each language into which the application is to be translated, the operating system of the mobile device can select the appropriate resource file corresponding to the system language to localize the application when it is loaded. Localization is the process of adapting software for a specific region or language by adding locale-specific components and translating text. In addition, a localization refers to a set of data that is used to localize an application. The system language of an operating system for a mobile device can be generally set by a user via a configuration option and text strings presented by the user interface of the operating system are then presented in the system language. When executing an application, operating systems attempt to locate and use a resource file for the application corresponding to the system language to localize the application. If a resource file for the system language is unavailable for the application, the operating system selects the default resource file (i.e., corresponding to a default language, such as English) for the application.

In other cases, applications are only available in a single language; that is, they are packaged with a single resource file.

Due to the high number of system languages that are available in the operating system of a mobile device, it can be challenging for an application developer to generate and package the requisite resource files for each language with the application. In many cases, application developers operate on a small budget and do not have the expertise nor the means required to generate these numerous resource files. Further, due to the limited storage available on some mobile devices, it can be undesirable to store all of the resource files for each language. Still further, the cost of downloading the additional data corresponding to the additional resource files, or additional content in a resource file, for all languages can make their inclusion in the application package unattractive.

Accordingly, it is an object of the invention to provide a novel method and system for localizing an application on a computing device.

### SUMMARY OF THE INVENTION

According to an aspect of the invention, there is provided a method for localizing an application on a computing device, comprising:

determining, via a software agent executing on a computing device, if a localization is available on a server computer for an application installed on said computing device;

receiving said localization if available; and

installing said localization on said computing device.

The localization can correspond to a system language of the computing device.

The method can further include:

generating a first list of applications installed on said computing device; and

comparing said first list to a second list of applications for which localizations are available on said server computer to generate a third list of applications that are in both said first and second lists.

The method can further include enabling a user of said computing device to select at least one application in said third list for localizing.

The localization can be a resource file.

According to another aspect of the invention, there is provided a system for localizing an application on a computing device, comprising:

a server computer storing localizations for a set of applications; and

a computing device executing a software agent downloading and installing one of said localizations stored by said server computer corresponding to an application installed on said computing device, said computing device using said one localization when executing said application.

The server computer can be configured to provide a list of the set of the applications upon request. The localizations can include resource files including translated text strings.

According to a further aspect of the invention, there is provided a method for localizing an application on a computing device, comprising:

reading, via a software agent executing on a computing device, resources for an application stored in storage of said computing device;

determining if text strings in said resource file require localization;

translating said text strings to a system language of said computing device; and

using said translated text strings with an associated application when executed on said computing device.

The determining can include determining via a user interface control framework if the text strings require localization.

The translating can include:

directing a translation module on said computing device to translate said text strings.

The translating can include transmitting said text strings to a server computer for translating.

The translating can include translating said text strings using a dictionary on said computing device.

The method can include transmitting said translated text strings to a server computer for reuse by other computing devices.

The computing device can be a mobile device.

According to still another aspect of the invention, there is provided a method for localizing an application on a computing device, comprising:

determining, via a software agent executing on a computing device, if a resource file for an application installed on said computing device is available on a server computer for a system language of said computing device;

if said resource file for said system language is available on said server computer:
receiving and installing said resource file on said computing device;

and

if said resource file is unavailable on said remote server computer:
translating text strings for controls of said application to said system language.

The translating can include determining, via a user interface control framework of said computing device, if text strings loaded for said application require localization.

The translating can include directing a translation module on said computing device to translate text strings loaded for said application.

The translating can include transmitting said default text strings to a server computer for translating.

The translating can include translating said default text strings using a dictionary on said computing device.

The translating can include transmitting said translated default text strings to a server computer for reuse by other computing devices.

The computing device can be a mobile device.

If the resource file is unavailable on the remote server computer, the default text strings that cannot be reliably translated to the system language can be used.

According to yet another aspect of the invention, there is provided a system for localizing an application on a computing device, comprising:

a server computer having storage and a processor;

at least one localization for an application for a computing device stored in said storage; and

computer-executable instructions executed by said processor, said processor, when executing said computer-executable instructions, receiving a request from a computing device for one of said localizations, and transmitting said one localization corresponding to said request to said computing device.

According to still yet another aspect of the invention, there is provided a method for localizing an application on a computing device, comprising:

determining, via a software agent executing on a computing device, if a localization is available external to said computing device for an application installed on said computing device;

receiving said localization if available; and

installing said localization on said computing device.

During the determining, the software agent can determine if the localization is available on a storage medium accessible to the computing device.

According to another aspect of the invention, there is provided a method for localizing an application on a computing device, comprising:

capturing an image of a control of a user interface of an application executing on a computing device;

performing optical character recognition on said image to recognize a text string of said control;

translating said recognized text string; and

displaying a modified image of said control with said translated text string in place of said image of said control.

According to still yet another aspect of the invention, there is provided a method for localizing an application on a mobile device, comprising:

determining, via a software agent executing on a mobile device, if a localization is available on a server computer for an application installed on said mobile device;

receiving said localization if available; and

installing said localization on said mobile device.

### BRIEF DESCRIPTION OF THE DRAWINGS

Embodiments will now be described, by way of example only, with reference to the attached Figures, wherein:

FIG. 1 shows a high-level architecture of a system for localizing an application on a mobile device in accordance with an embodiment of the invention and its operating environment;

FIG. 2 shows a schematic diagram of the localization server of FIG. 1;

FIG. 3 shows a schematic diagram of the mobile device of FIG. 1;

FIG. 4 is a flowchart of the method of preparing an application for localization by the system of FIG. 1;

FIG. 5 shows the extraction of resource files for the Microsoft Windows Mobile platform;

FIGS. 6A to 6C show a flowchart of the general method for localizing an application on a mobile device using the system of FIG. 1;

FIGS. 7A and 7B illustrate a screenshot of a menu screen and an information screen of an application prior to localization respectively;

FIG. 8 is a flowchart of the method of preparing a Google Android application for localization by the system of FIG. 1;

FIG. 9 shows the extraction of resource files for the Google Android platform;

FIG. 10 shows the extraction of resource files for the Google Android platform;

FIG. 11 illustrates the contents of the resource file extracted in FIG. 9;

FIG. 12 illustrates the compiling of the resource file extracted in FIG. 9;

FIG. 13 illustrates a screenshot of an application for localizing applications on the Google Android platform that is executed on the mobile device of FIG. 1; and

FIG. 14 illustrates a screenshot of the menu screen of the application of FIG. 7A after localization.

### DETAILED DESCRIPTION OF THE EMBODIMENTS

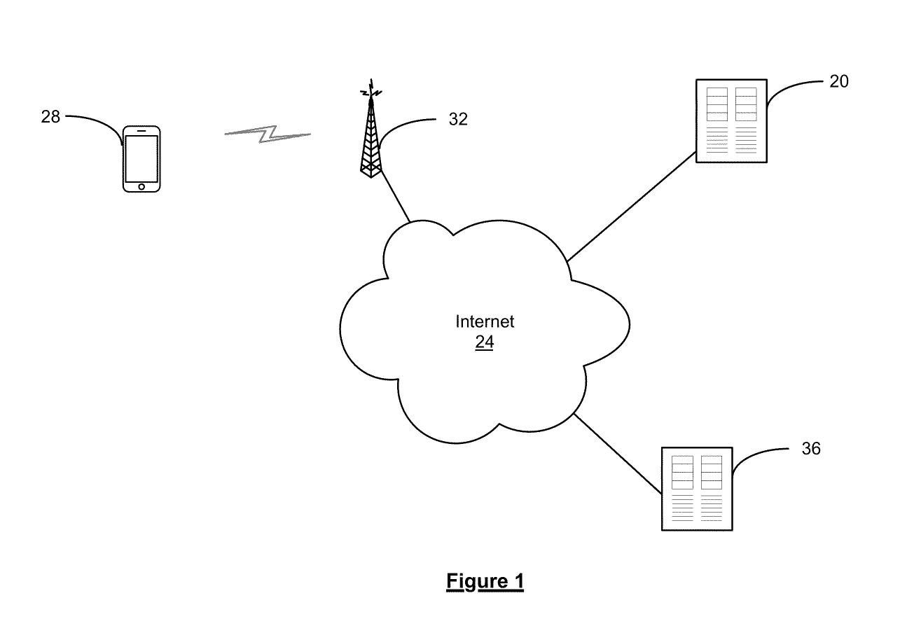

A system for localizing an application on a computing device and its operating environment is shown in FIG. 1. The system includes a localization server 20 that is a server computer system storing localizations for a set of applications is coupled to the Internet 24. While, in this particular embodiment, the Internet 24 is shown, any other communications network enabling communications between the various devices can be substituted. A mobile device 28 is also in communication with the Internet 24 via a cellular base station 32 using cellular communications. The cellular base station 32 enables communications over the Internet 24 via a number of intermediate servers operated by one or more cellular communications carriers (not shown).

An application store server 36 is also shown coupled to the Internet 24. The application store server hosts a plurality of application packages that can be browsed and selected for installation by a user via an application store application executing on the mobile device 28. The user has an account that is charged for the applications that he or she selects to install. Once payment is processed, the application store application downloads the purchased applications from the application store server 36 and installs them on the mobile device 28.

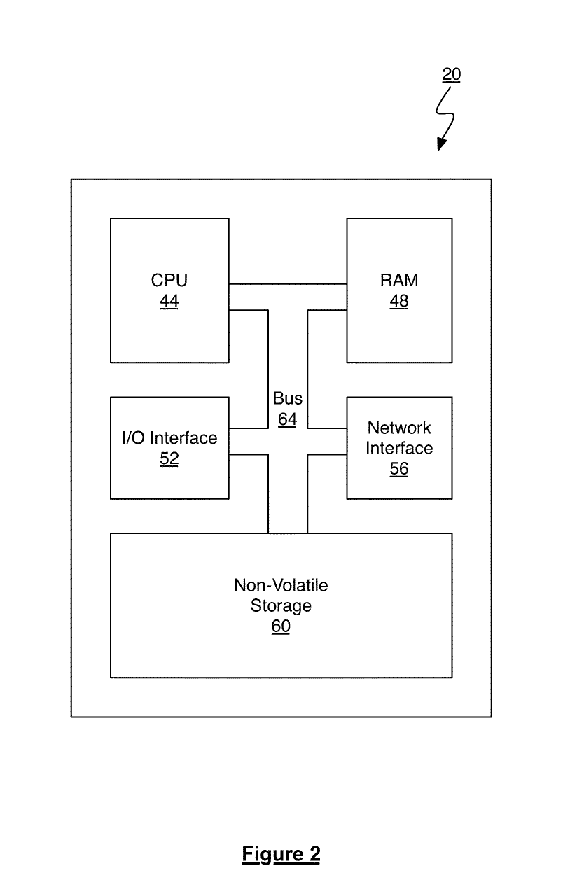

FIG. 2 shows various physical elements of the localization server 20. As shown, the localization server 20 has a number of physical and logical components, including a central processing unit (“CPU”) 44, random access memory (“RAM”) 48, an input/output (“I/O”) interface 52, a network interface 56, non-volatile storage 60, and a local bus 64 enabling the CPU 44 to communicate with the other components. The CPU 44 executes an operating system and an application localization service. RAM 48 provides relatively-responsive volatile storage to the CPU 44. The I/O interface 52 allows for input to be received from one or more devices, such as a keyboard, a mouse, etc., and outputs information to output devices, such as a display and/or speakers. The network interface 56 permits communication with other computing devices. Non-volatile storage 60 stores the operating system and programs, including computer-executable instructions for implementing the application localization service, and the localization data. During operation of the localization server 20, the operating system, the programs and the data may be retrieved from the non-volatile storage 60 and placed in RAM 48 to facilitate execution.

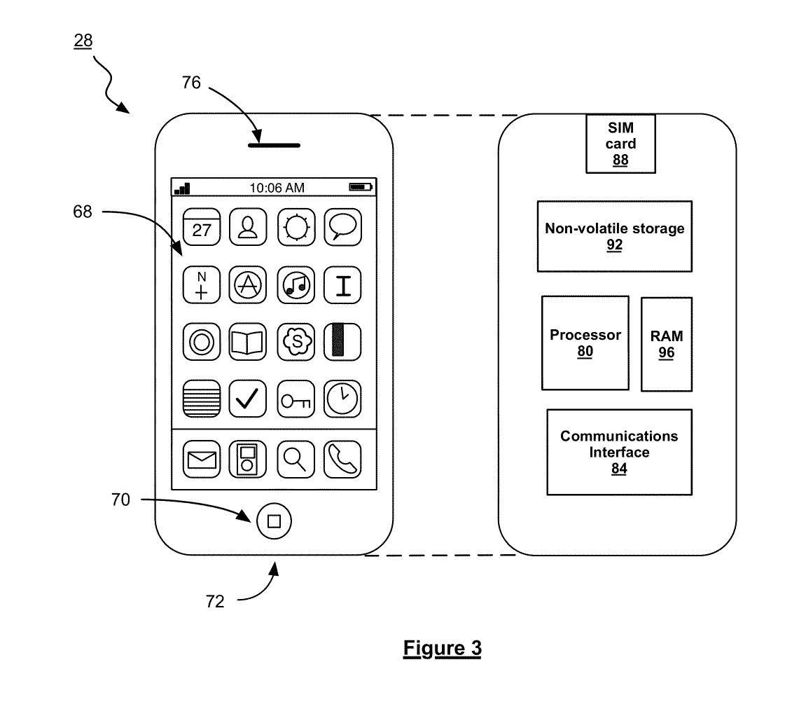

FIG. 3 shows various physical elements of the exterior and interior of the mobile device 28. As shown, the mobile device 28 has external components, including a touchscreen 68, a user button 70, a microphone 72 along the bottom edge of the mobile device 28, and a handset speaker 76. The touchscreen 68 enables the display of messages and other information to a user of the mobile device 28, and allows a user to interact with the user interface of the operating system and applications on the mobile device 28. The user button 70 switches the mobile device 28 between modes and triggers functions of the mobile device 28. The microphone 72 enables a user to register audio input, such as their voice. The handset speaker 76 enables the user to listen to audio output from the mobile device 28. Volume control buttons, a power button, a mute button, a hands free speaker, a cable port, a headphone jack, and a camera aperture are also present on the exterior of the mobile device, but are not shown in FIG. 3. Internal components of the mobile device 28 include a processor 80, a communications interface 84, a subscriber identity module (“SIM”) card 88 and storage. The storage typically includes non-volatile storage 92 and random access memory (“RAM”) 96. The non-volatile storage 92 stores the operating system, applications and data used by both the operating system and the applications. Configuration data for the mobile device 28 is also stored in non-volatile storage 80. In addition, the non-volatile storage 92 stores computer-executable instructions for localizing applications, one or more language dictionaries, and the localization data. The processor 80 executes the operating system and retrieves the applications from non-volatile storage 92 and loads them in RAM 96 for execution. RAM 96 is generally faster storage than non-volatile storage 92 and may be more reliable when written to numerous times. The communications interface 84 enables the processor 80 to communicate with other computing devices such as the localization server 20 and the application store server 36 over the Internet 24. The communications interface 84 can include one or more cellular radios for communicating with the cellular base station 32, one or more short-range wireless radios, and one or more communications cable interfaces. The cellular radios can be for communications via an iteration of Code Division Multiple Access (“CDMA”) and/or Global System for Mobile communications (“GSM”). The short-range wireless radios can be for communications in accordance with an iteration of WiFi, Worldwide Interoperability for Microwave Access (“WiMAX”), Bluetooth, etc. The communications cable interfaces can include Universal Serial Bus (“USB”), Micro-USB, etc. The SIM card 88 is an integrated circuit that securely stores a service-subscriber key that is used to associate a subscriber with a mobile device in which the SIM card 88 is installed. In addition, the SIM card 88 also provides storage.

The mobile device 28 is distributed with a particular configuration of operating system, applications and settings for both. The particular configuration may vary by handset manufacturer, carrier, country, etc. The system language of the mobile device 28 is the language in which menus of the user interface of the operating system are presented to a user. It is set to a first language by default, and may be changed by a user to one of a set of alternate languages provided with the operating system. For example, Apple's iOS 5 devices enable a user to select one of the following languages as the system language: U.S. English, British English, French, German, Chinese (traditional and simplified), Japanese, Dutch, Italian, Spanish, Portuguese, Brazilian Portuguese, Danish, Finnish, Norwegian, Swedish, Korean, Russian, Polish, Turkish, Ukrainian, Arabic, Croatian, Czech, Greek, Hebrew, Romanian, Slovenian, Thai, Indonesian, Malaysian, Catalan, Hungarian and Vietnamese. Mobile device operating system developers are often large companies with significant resources. In order to ensure that mobile devices empowered by their operating system can be sold to as many markets as possible, they translate the interface and documentation for their operating systems into a large number of languages.

Applications for mobile devices (sometimes referred to as “mobile applications”), on the other hand, may be developed by development companies that range from large (such as the same companies that develop the operating systems), to small (with a handful of developers). In recent years, with advancements in application development tools, even individuals are able to design, develop and deploy applications. In most cases, application developers elect to release their applications in one or a few languages. They typically select a first language, such as U.S. English, and then may also translate text elements of the user interface of the application into one or more additional languages that provide them access to significantly-large markets. As a result, some users may not readily be able to utilize an application, as they are not able to understand the text of the user interface. This can be particularly frustrating for users where it is unclear at the time of purchase whether the application has been translated into the user's preferred language. At the same time, application developers miss out on sales and/or user acceptance in some markets. Reduced “stickiness” of an application can attribute to poor revenue in some circumstances, such as where in-application purchases can be made.

Generally, applications can be localized by translating a set of text strings used to generate user interface elements. The storage location of these strings can vary by operating system. For the Microsoft Windows Mobile platform, the application executable stores the default language text strings, and text strings for localizing an application are stored in separate resource files for each alternate language. In contrast, in the Google Android platform, the text strings for localizing an application for all languages are stored in a single resource file that is compiled. For purposes of simplicity, the localization of an application will be described for the Windows Mobile platform.

When one or more localizations are generated for an application by the developer, the corresponding resource files are included in the application package. The application package, including all of the provided resource files, is then installed on the mobile device 28. A default resource file is specified by the developer. When an application is launched by the operating system, the operating system loads the application, and looks for a resource file corresponding to the system language. If the resource file is located, it is loaded. If it is not located, the default text strings stored in the application executable are loaded.

The system uses a two-pronged approach to localizing applications. A localization software agent (hereinafter referred to as a “localization agent”) first determines if a localization for the system language is available for an application. The localizations in this embodiment are resource files that include translated text strings. If it is, the localization agent receives and installs the localization. If a localization is unavailable for the application, the localization agent enables real-time localization of the application. Real-time localization is enabled by the localization agent by setting a flag for the application. As a result, the user interface control framework of the operating system of the mobile device 28 translates or causes to be translated the text strings of user interface controls of the application. In this manner, the localization agent can use pre-generated localizations where available, and localize the application at run-time where a previously-generated localization is unavailable. It can be desirable to use pre-translated resource files if available as a greater level of quality of translation can be achieved in many cases relative to one generated in real time. Further, real-time localization generally utilizes more processing time.

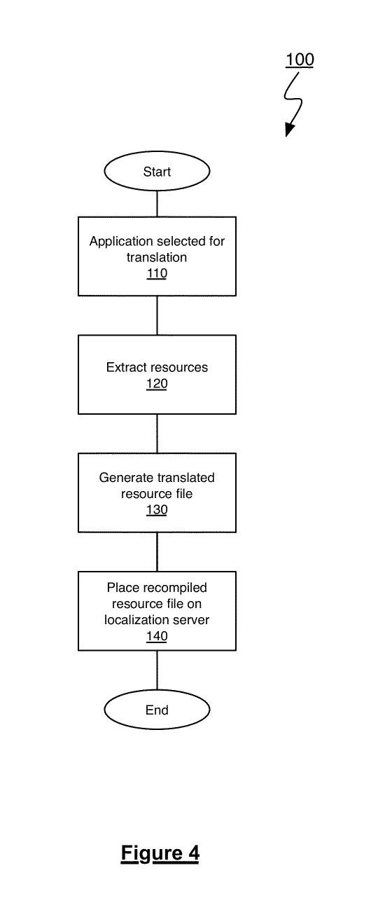

FIG. 4 shows a method of preparing applications for localization generally at 100. In the method 100, the resources (i.e. in this embodiment, text strings for populating text elements of the user interface controls) of an application are translated and made available for downloading to facilitate localization of the applications on a mobile device upon which it is installed. Any computing device, such as the localization server 20, can be used to prepare an application for localization.

The method 100 commences with the selection of an application for localization (110). The application may be selected based on global popularity, regional popularity, user requests or votes for translation of the application, a desire by its developer to see it localized, etc. Upon selection of an application, resources are extracted from the application package for the application (120). The application package contains an executable for the application that stores resources for the default language of the application.

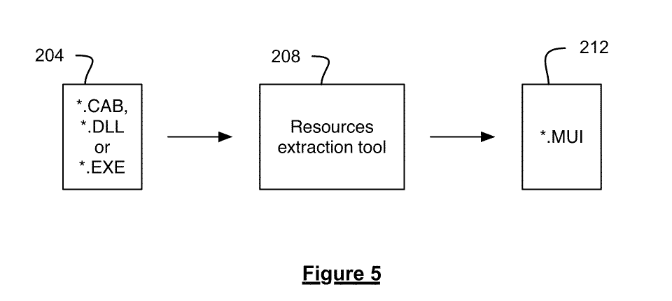

FIG. 5 illustrates the extraction of resources from an application package for the Windows Mobile platform. An application package 204 for Windows Mobile is shown as being either a .CAB, a .DLL or an .EXE file. A resources extraction tool 208 is used to extract the resources and generate an extracted resource file 212. The extracted resource file 212 is a Multilingual User Interface (“MUI”) file with a .MUI extension, in accordance with the standard established by Microsoft for resource files.

Returning again to FIG. 4, once the resources have been extracted from application package at 120, a translated resource file is generated (130). Each text string in the extracted resource file 212 is translated. The translation is done separately using standard translation tools, such as Trados, which use a translation database to automatically translate matched words. Some words may not be found in the translation database and are left untranslated by the translation tool. A human translator confirms or revises the translation, as appropriate, and adds missing translations, if any. Next, all of the translated text is imported back into the extraction and localization tool for generation of a translated resource file.

Upon translation of the extracted resource file, the translated resource file is stored on the localization server 20 (140). In addition, a registry of localizations maintained by the localization server 20 is modified for the newly-translated resource file. In particular, the following information is added to the localization registry for the newly-translated resource file: the application name and version, the Universal Resource Locator (“URL”) of the translated resource file, the file size of the translated resource file and the installation destination on a mobile device.

Upon storing the translated resources on the localization server 20, the method 100 of preparing the application for localization ends. Once the translated resource file is stored on the localization server 20, applications may be localized as described below.

By translating the resource file for an application for use on a mobile device and making the translated resource file available for download, the application can be localized after release by a third-party. This is beneficial where, for example, users desire a localized version of the application and the developer does not provide one. Further, a developer can develop and release an application in a single language, and then localize the application for regional markets as it gains popularity, thereby postponing localization costs.

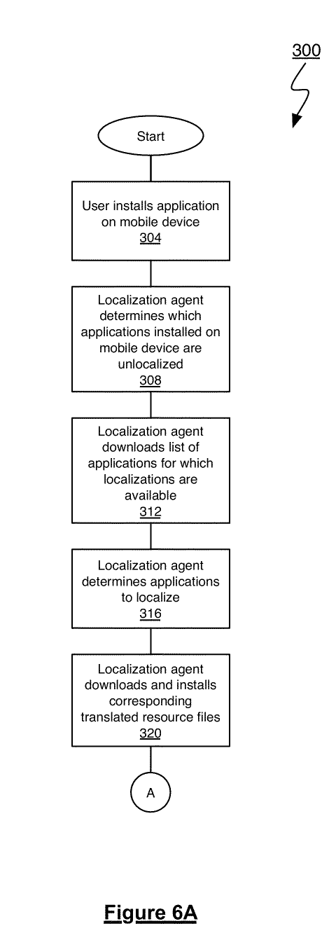

FIGS. 6A to 6C illustrate the general method 300 of localizing an application on a computing device 28 used by the system of FIG. 1. When an application is launched, resources matching the system language are loaded if present, otherwise the default resources are loaded. Where an application has been selected for localizing by the user, but a translated resource file is unavailable for download from the localization server 20, the localization agent enables the translation of the text elements of user interface controls of the application as it is being initialized after the application is loaded into RAM 96. As a result, any controls like lists, text boxes, static check boxes, etc. that are being initialized to load a specific text string value initiate a translation request for that string and load the result of the translation. If there is no translation available for that text string, the original text string is loaded.

The mobile device 28 stores and executes computer-executable instructions for localizing applications on the mobile device 28. The computer-executable instructions take the form of a localization agent, a translation-aware user interface control framework, and a translation module for localizing applications that may be placed on the mobile device 28 in a number of manners. In particular, the localization agent identifies and downloads translated resource files for applications installed on the mobile device 28 and flags other applications for run-time translation. The localization agent includes a localization application that is either placed on the mobile device 28 at provisioning or is made available for downloading by a user on an application store, such as that operated by application store server 36. The user interface control framework is translation-aware and can request the translation of text strings for user interface controls by the translation module at run-time.

The method 300 commences with the user installing an application that needs localizing on the mobile device 28 (304). The user browses an application store run on the application store server 36 and locates an application that he or she wishes to install. Upon selecting the application for installation, the application is downloaded and installed on the mobile device 28.

The localization agent then determines which applications installed on the mobile device have not been localized (308). This occurs when the user launches the localization application on the mobile device 28. The localization application searches the mobile device 28 for applications that are installed. Upon generating a list of applications installed on the mobile device 28, the localization application determines which are already localized; that is, which applications already have resource files available for the system language. The localization application calls special localization APIs that examine the application package for each installed application to determine if localizations are present that match the system language and if translated resource files were previously installed for this application. The balance of the applications are deemed not have been localized.

Upon determining which applications installed on the mobile device at 308 are unlocalized, the localization application downloads a list of applications for which localizations are available from the localization server 20 (312). In particular, the localization application sends a request for this list to the localization server 20. In response, the localization server 20 transmits a copy of the localization registry to the mobile device 28. As previously noted, the localization registry includes the name, version, URL, file size, and installation destination for each translated resource file on the localization server 20.

After receiving the list of applications for which translated resource files are available on the localization server 20, the localization application determines the list of applications to localize (316). The localization application compares the list of applications for which localizations are available on the localization server 20 received at 312 to the list of applications installed on the mobile device 28. The localization application presents a list of applications installed on the mobile device 28. Further, the localization application indicates in the list which applications localizations are available to be downloaded for. A checkbox is presented beside each application in the list. If the application is already localized on the mobile device 28, the checkbox is checked.

The localization agent then downloads and installs translated resource files corresponding to the list of applications selected for localizing at 316 for which localizations are available from the localization server 20 (320). For each application selected at 316 for localization for which a localization is available from the localization server 20, the localization agent downloads the translated resource file from the localization server 20 using the URL for the localization registry received at 312. The localization agent then places the downloaded translated resource file in the installation destination identified in the localization registry. Once the translated resource file is installed, it is be used by the operating system to localize the application. The application launcher recognizes the existence of the newly-downloaded translated resource file that matches the system language and loads it in place of the default resources in the application executable.

Translated resource files can be removed from the mobile device 28 using the localization application. A user can achieve this by unchecking a checkbox beside an application in the list of applications presented by the localization application for which a localization was installed. The localization application then removes the localized resource file from the mobile device 28. This causes the default resources for the application to be loaded when the application is executed.

The localization agent can, where localizations are available on the localization server 20, localize applications installed on the mobile device 28. For applications selected for localization by the user for which localizations are unavailable on the localization server 20, the localization agent uses a different approach.

The localization application sets a flag for applications selected for localization by a user for which localizations are unavailable (322).

Next, an application is launched on the mobile device 28 (324). The application launcher determines if a resource file matching the system language is present on the mobile device 28 (328). If a resource file matching the system language is present, the application launcher loads the located resource file and writes it to RAM 96 (332). If, instead, a resource file matching the system language is not present, the application launcher loads the default resources from the application executable and writes them to RAM 96 (336). Next, the user interface control framework of the mobile device 28 is assigned the loaded resources (340). The user interface control framework then determines if the application is to be translated at run-time (344). In particular, the user interface control framework determines if the flag has been set for the application by the localization application. The core part of the user interface control framework is adjusted to be translation-aware. That is, when the localization agent has flagged an application for translation at run-time, all of the user interface controls detect this flag and request high-performance translation for the text of the user interface controls.

If the flag is set, then the application is to be translated at run-time, otherwise the resources loaded are to be used. If it is determined that the application is not to be translated at run-time (i.e., its flag is not set), the user interface control framework uses the resources loaded at 332 or 336 (348). If, instead, it is determined that the application is to be translated at run-time, the user interface control framework requests translation of the resources assigned at 340 while initialized (352). The user interface control framework requests translation of the resources from the translation module that includes high-performance run-time translation APIs accessing optimized language dictionaries and returns the result to the user interface control framework. It is determined if the resources can be translated (356). The results returned to the user interface control framework may include some text strings that were translated and other text strings that could not be translated reliably by the translation module. Where a text string of the resources could not be translated reliably by the translation module, the user interface control framework uses the loaded resources assigned at 340. For those text strings that could be translated reliably by the translation module, the user interface control framework loads the translated resources (360). The user interface control framework replaces the particular resources with the translated ones. Upon loading the resources and translating them, where possible, the method 300 ends.

In this manner, applications can be localized in run-time by having their resources (i.e. in this case, text strings) translated at the time the resources are initialized.

For the Google Android platform, the implementation is modified slightly. As previously noted, Google Android application packages include a single resource file that holds the text strings in one or more languages. Further, the resource file is compiled.

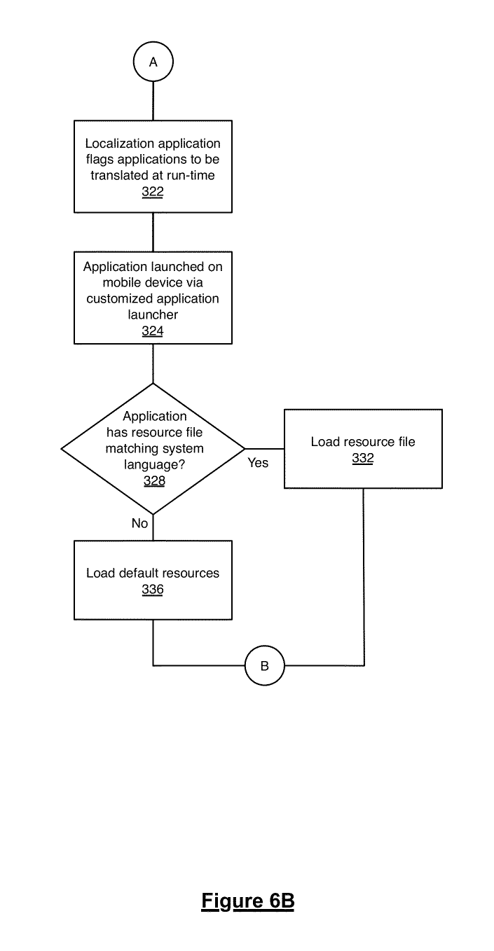

FIGS. 7A and 7B show a menu screen and an information screen respectively for an exemplary application called PicSay in order to illustrate the localization of an application for the Google Android platform. The menu screen shows a number of menu options that are represented by images and English text elements. The information screen shows information about PicSay. The stylized name of the application shown at the top of the information screen is, in fact, an image, but the remainder of the information on the information screen is a set of text strings. The images are stored within the PicSay application, while the text strings are stored in a separate resource file.

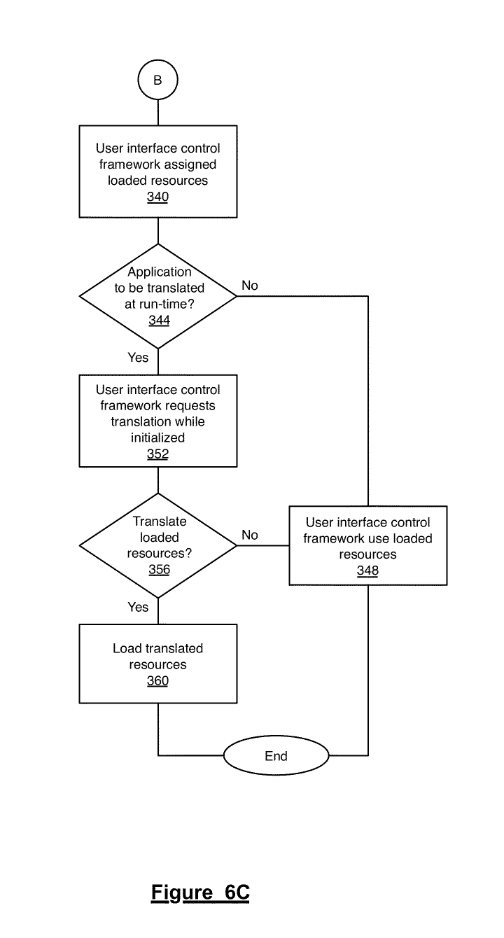

FIG. 8 shows a method of preparing Google Android applications for localization generally at 400. The method 400 differs slightly from the method shown in FIG. 4 due to the manner in which localizations are stored in the Android platform.

The method 400 commences with the selection of an application for localization (404). The application may be selected based on global popularity, regional popularity, user requests or votes for translation of the application, a desire by its developer to see it localized, etc. Upon selection of an application, the resource file is extracted from the application package for the application and decompiled (408). The application package contains a single resource file that is compiled. The resource file is decompiled to allow the reading of text strings in the resource file and the addition of text strings corresponding to a new language.

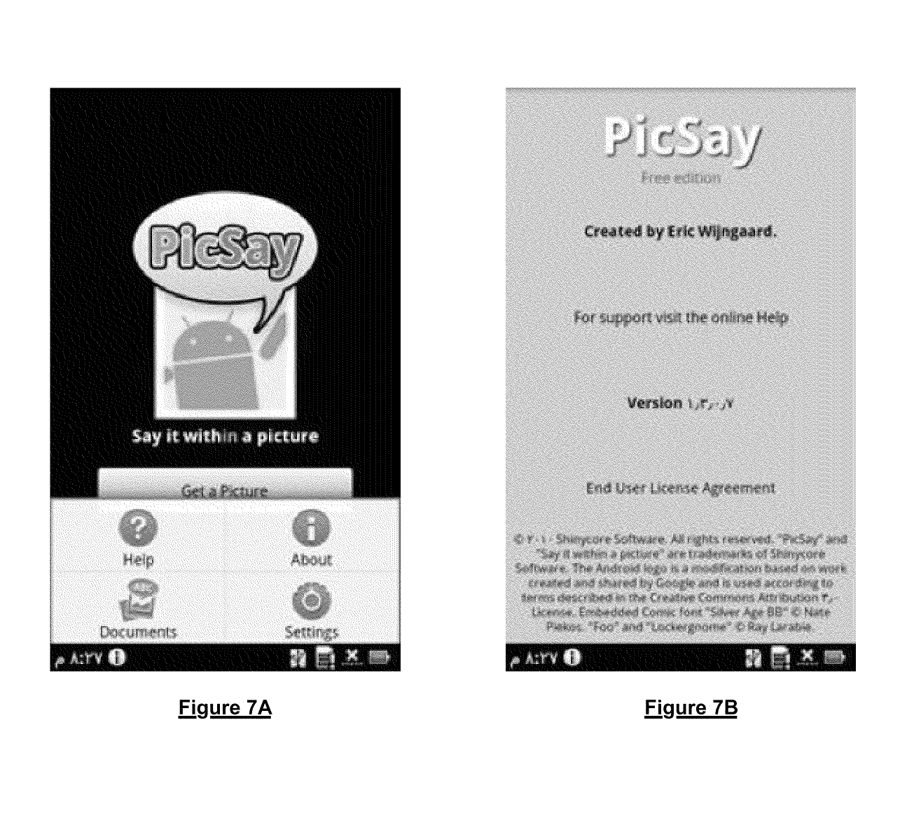

FIG. 9 illustrates the extraction and decompiling of a resource file from a Google Android application package 504 during 408 in the method 400 of FIG. 8. The Android application package 504 has an .APK extension, and includes a compiled resource file .ARSC 508 which can be extracted from the application package 504. A resource file 512 in an eXtensible Markup Language (“XML”) format is obtained by decompiling the compiled resource file 508. The resource file 512 includes text strings for one or more languages for user interface text elements of the application.

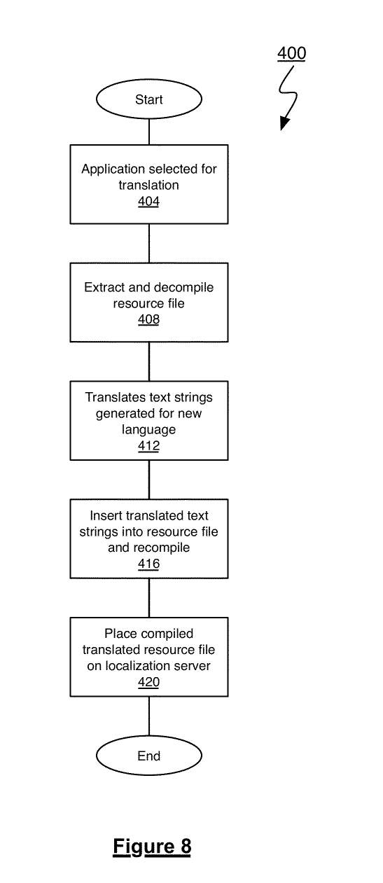

FIG. 10 illustrates an application package 504A for the PicSay application. A resource file extraction and localization tool 516 is used to extract a resource file 512A named Strings.XML from the application package 504A.

Returning again to FIG. 8, once the resource file has been extracted from application package at 408 and decompiled, translated text strings are generated for the new language corresponding to the localization (412). The set of text strings for the default language in the resource file are translated as noted above during 130 of method 100.

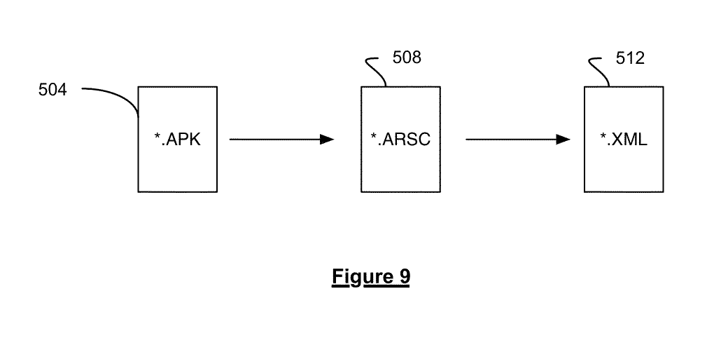

FIG. 11 shows a screen presented by the resource file extraction and localization tool 516 of FIG. 10 after extraction of the text strings for the default language from the resource file 512A. As shown, each text string is identified with an ID number that indicates which text element the text string relates to. A separate column enables translations for each text string to be registered.

Turning back to FIG. 8, once the translated text strings have been generated, they are inserted into the resource file and it is recompiled (416). The resource files for Google Android are recompiled to enable their use together with the application package on a mobile device 28.

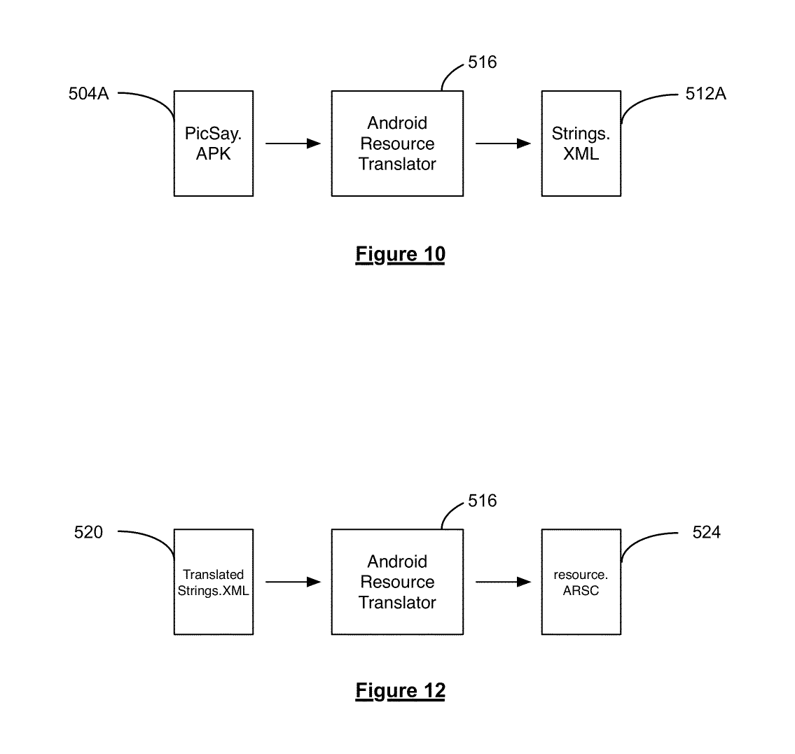

FIG. 12 shows the compiling of a resource file 520 for the Google Android operating system for the PicSay application. The resource file 520 includes the translated text strings for the new language. The resource file extraction and localization tool 516 is used to recompile the resource file 520 to generate a recompiled resource file 524.

Returning again to FIG. 8, the recompiled resource file including the translated text strings for the new language is then placed on the localization server 20 (420). In addition, the registry of localizations maintained by the localization server 20 is modified for the newly-translated resource file. In particular, the following information is added to the localization registry for the newly-translated resource file: the application name and version, the URL of the translated resource file, the file size of the recompiled resource file and the installation destination on a mobile device.

Upon storing the recompiled resource file on the localization server 20, the method 400 of preparing the Google Android application for localization ends.

Once the recompiled resource file containing text strings for the new language is stored on the localization server 20, applications may be localized using a method similar to method 300 as described above, with some modifications. One approach is to modify the operating system's application launcher to look for alternative resource files that may contain text strings matching the system language at the time of execution. Application packages, including the compiled resource files, are signed to ensure that they have not been tampered with, enabling the operating system to “trust” the included application. While Windows Mobile is designed to readily accept separate resource files for applications, the default application launcher for Google Android will only load resource files that form part of the signed application package for an application. As a result, in order to enable Google Android to accept a third-party translated resource file, the application launcher may be modified to use resource files external to the application package. Another approach is to modify the operating system to accept modified application packages. In this manner, the recompiled resource file can substitute the original compiled resource file in the application package. Still another approach is signing of a modified application package with a trusted certificate that is accepted by the application launcher.

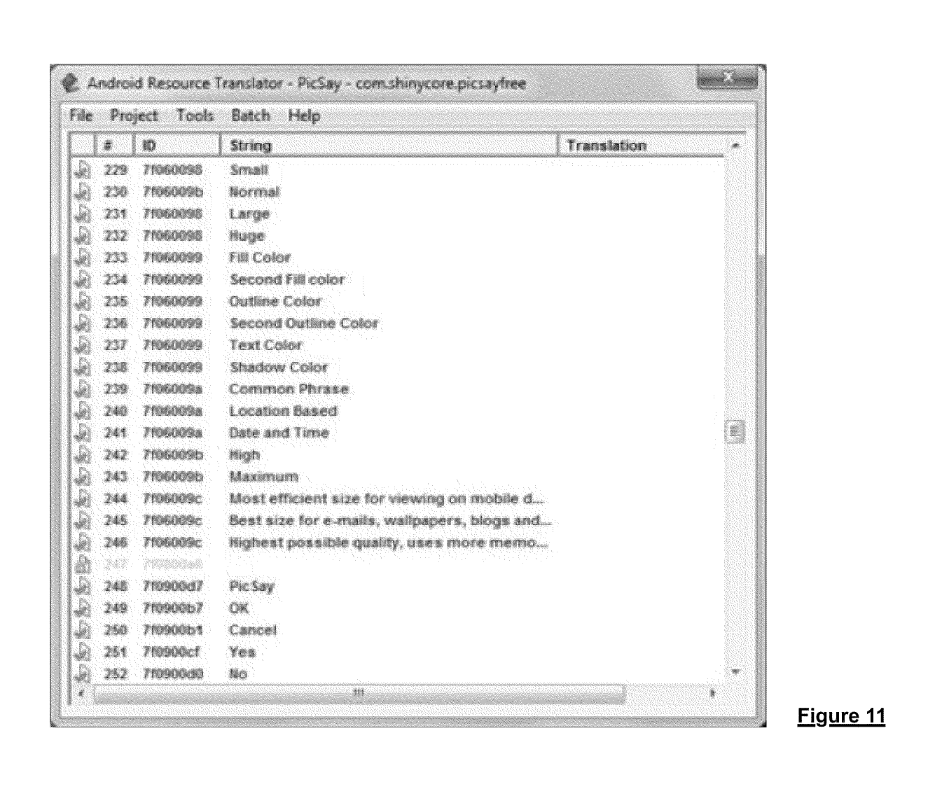

FIG. 13 shows an application selection screen presented by the localization application. The list of applications for localization only includes one application, PicSay, in this case. The user can select to localize the applications presented by checking a checkbox beside the applications, or can alternatively leave the checkbox unchecked to keep the application unlocalized. An application previously localized in this manner can be “unlocalized” by unchecking the previously-checked checkbox for the application, causing the localization application to delete the installed localization. Upon execution, the “unlocalized” application is loaded with its default resources.

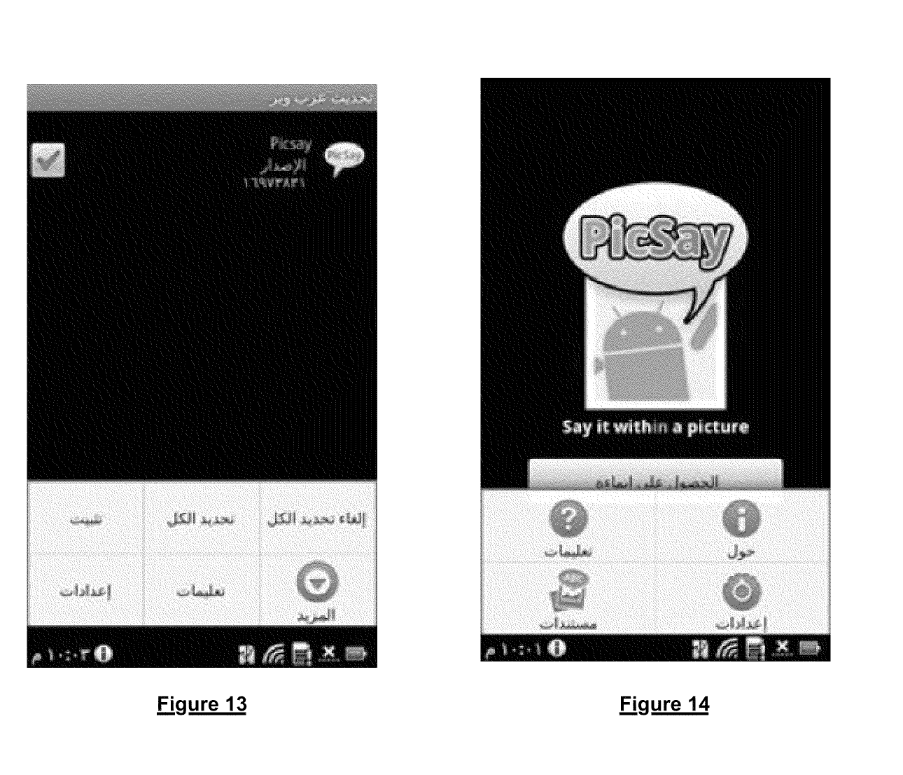

FIG. 14 illustrates the menu screen of the PicSay application of FIG. 7A after localization. As can be seen, the images are all unmodified, but the text elements have been replaced with translated text strings.

As will be appreciated, the localization agent can be installed on the mobile device after installation of an application to be localized.

As an alternative embodiment, the application launcher can translate the default resource file it if could not find the matching resource file with the system language. In this case, the resource file is translated and stored in the usual place a translated resource file is downloaded to. This operation is done only once at the first launch then the translated resource file will be thereafter kept and used on the device. Moreover, the translated resource file can be uploaded to the localization server and made available for other users to download.

In another alternative embodiment, some or all of the translation can be performed remotely. For example, the localization agent and/or the translation module can transmit the resource file to a server for translation, such as via Google Translate. Alternatively, the localization agent and/or the translation module may make calls to a server to translate some or all of the text strings found in a resource file, potentially negating the need for a translation dictionary on the mobile device 28. For example, the translation module may determine that it can translate some of the text strings with a satisfactory level of confidence but that it cannot translate the balance of the text strings with a satisfactory level of confidence. It may then transmit these text strings to a server that possesses stronger translation functionality for translation.

In another alternative embodiment, the operating system of the mobile device 28 is modified to permit modification of the checksum for application packages. In this manner, localized resource files can be placed in the application packages without causing the application package to be treated as untrusted by the operating system.

In a further alternative embodiment, the translated resource files can replace one or more resource files in the application package stored on the mobile device.

Resources can also be translated after placement in RAM 96. Still further, text strings within an application can be translated by intercepting instructions for displaying the user interface of the application and translating the text strings therein, before passing on the instructions to the display application programming interface(s) of the operating system of the mobile device 28.

While the invention was described with particularity to mobile devices, other types of computing devices can be used with the invention.

High-quality optical character recognition that is customized to work on default user interface fonts can be used to read the text inside a control after being captured as an image, then display a modified image of the control with the translation and display or print it on top of the control location on the screen.

Computer-executable instructions for implementing the application localization method on a computing device could be provided separately from the computing device, for example, on a computer-readable medium (such as, for example, an optical disk, a hard disk, a USB drive or a media card) or by making them available for downloading over a communications network, such as the Internet.

While the invention has been described with specificity to certain operating systems, the specific approach of modifying he methods described hereinabove will occur to those of skill in the art.

The localization server can alternatively store application packages that include the translated resources. In this case, the localization agent can download and install the revised application package including the translated resources to localize an application. In a further embodiment, text and images directly embedded in the application can be translated and the modified application or application package can be downloaded and installed by a localization agent on the mobile device.

While the system was described with specificity to the storage of localizations on a localization server, they can also be made available from other locations. For example, localizations can also be made available to the computing device by external storage, such as a memory card, a optical storage disk, etc.

While the localization server is shown as a single physical computer, it will be appreciated that the localization server can include two or more physical computers in communication with each other. Accordingly, while the embodiment shows the various components of the localization server residing on the same physical computer, those skilled in the art will appreciate that the components can reside on separate physical computers.

The application translation can be extended to the translation of the contents display inside an application and usually received from an external server. Contents such as news, weather, user-generated content, and articles can be translated using external contents localization web service and the contents returned to the application and displayed on the right place.

Alternate resources may be translated in place of the default resources used in the embodiment described above. For example, if resources in a Windows Mobile application package include text strings for one or more alternate languages, the resources for one or more languages may be used to generate a localization. It can be useful to use resources for two or more languages as it may help address issues where a word/phrase/etc. in one language has more than one translation in an alternate language, as the combination of the resources for the two or more languages may resolve the translation to a single word/phrase/etc.

The localization server may be store a list of localizations and URLs identifying one or more other servers upon which the localizations are stored.

Resources can be localized to a language other than the system language. For example, the system language may not be the preferred language of the user, as the user's preferred language may not be available from the operating system. The localization agent may permit the user to specify a language other than the system language for localizing applications.

The above-described embodiments are intended to be examples of the present invention and alterations and modifications may be effected thereto, by those of skill in the art, without departing from the scope of the invention that is defined solely by the claims appended hereto.

What is claimed is:

1. A method for localizing an application on a computing device, comprising:
determining, via a software agent executing on a computing device, if a localization is available on a server computer for an application installed on said computing device;
receiving said localization if available; and
installing said localization on said computing device.

2. The method of claim 1, wherein said localization corresponds to a system language of said computing device.

3. The method of claim 2, further comprising:
generating a first list of applications installed on said computing device; and
comparing said first list to a second list of applications for which localizations are available on said server computer to generate a third list of applications that are in both said first and second lists.

4. The method of claim 3, further comprising:
enabling a user of said computing device to select at least one application in said third list for localizing.

5. The method of claim 1, wherein said localization is a resource file.

6. A method for localizing an application on a computing device, comprising:
reading, via a software agent executing on a computing device, resources for an application stored in storage of said computing device;
determining if text strings in said resources require localization;
translating said text strings to a system language of said computing device; and
using said translated text strings with an associated application when executed on said computing device.

7. The method of claim 6, wherein said determining comprises:
determining via a user interface control framework if said text strings require localization.

8. The method of claim 6, further comprising:
directing a translation module on said computing device to translate said text strings.

9. The method of claim 6, wherein said translating comprises:
transmitting said text strings to a server computer for translating.

10. The method of claim 6, wherein said translating comprises:
translating said text strings using a dictionary on said computing device.

11. The method of claim 6, further comprising:
transmitting said translated text strings to a server computer for reuse by other computing devices.

12. The method of claim 6, wherein said computing device is a mobile device.

13. A method for localizing an application on a computing device, comprising:
determining, via a software agent executing on a computing device, if a resource file for an application installed on said computing device is available on a server computer for a system language of said computing device;
if said resource file for said system language is available on said server computer:
receiving and installing said resource file on said computing device;
and
if said resource file is unavailable on said remote server computer:
translating default text strings for controls of said application to said system language.

14. The method of claim 13, wherein said translating comprises:
determining, via a user interface control framework of said computing device, if text strings loaded for said application require localization.

15. The method of claim 13, wherein said translating comprises:
directing a translation module on said computing device to translate text strings loaded for said application.

16. The method of claim 13, wherein said translating comprises:
transmitting said default text strings to a server computer for translating.

17. The method of claim 13, wherein said translating comprises:
transmitting said translated default text strings to a server computer for reuse by other computing devices.

18. The method of claim 13, further comprising:
if said resource file is unavailable on said remote server computer, using said default text strings that cannot be reliably translated to said system language.
